(19) United States
(12) Patent Application Publication
(10) Pub. No.: US 2020/0149572 A1
(43) Pub. Date: May 14, 2020

(54) Connector Structure for Combination Shelf

(71) Applicant: Cheng-Chao Lin, Taichung City (TW)

(72) Inventor: Cheng-Chao Lin, Taichung City (TW)

(21) Appl. No.: 16/190,208

(22) Filed: Nov. 14, 2018

(51) Int. Cl. F16B 12/50

(52) U.S. Cl. CPC F16B 12/50

(57) ABSTRACT

A connector structure includes a connector body which has an end provided with an enlarged stop portion which is provided with a connecting section which has a diameter smaller than that of the connector body. The connecting section is provided with a recess which is formed between the enlarged stop portion and the connector body. In assembly, each of the connector bodies is initially inserted into the entrance of each of the steel angles, the connecting section of each of the connector bodies is then moved downward and inserted into the locking hole of each of the steel angles, and the recess of each of the connector bodies is then locked onto the inner wall and the outer wall of each of the steel angles, such that each of the connector bodies is secured to each of the steel angles.

### BACKGROUND OF THE INVENTION

### 1. Field of the Invention

The present invention relates to a connector structure and, more particularly, to a connector structure for a combination shelf

### 2. Description of the Related Art

A conventional combination shelf comprises four upright posts, a plurality of transverse connecting plates arranged between the upright posts, and a plurality of separation nets (or separation boards) placed on the transverse connecting plates. Each of the upright posts is provided with a plurality of hanging holes, and each of the transverse connecting plates is provided with a plurality of hanging portions hooked on the hanging holes of each of the upright posts. However, each of the transverse connecting plates has a determined thickness and decreases the storage space of the conventional combination shelf In addition, the number of the transverse connecting plates is too large and increases the cost of fabrication. Further, the transverse connecting plates are arranged between the upright posts, thereby decreasing the aesthetic quality of the conventional combination shelf

### BRIEF SUMMARY OF THE INVENTION

The primary objective of the present invention is to provide a connector structure for a combination shelf that is assembled easily and quickly.

In accordance with the present invention, there is provided a connector structure comprising a connector body. The connector body has an end provided with an enlarged stop portion. The enlarged stop portion is provided with a connecting section. The connecting section has a diameter smaller than that of the connector body. The connecting section is provided with a recess which is formed integrally between the enlarged stop portion and the connector body.

Preferably, the connector body has a substantially cylindrical shape.

Preferably, the enlarged stop portion has a circular shape, a hexagonal shape, a tetragonal shape or rectangular shape.

Preferably, the connector body has a periphery provided with two annular grooves, and two O-rings are mounted in the two annular grooves.

Preferably, the connector body is radially provided with a mounting recess.

Preferably, the connector body is radially provided with a through hole that is perpendicular to the ground, and a pin extends through the through hole. The pin has a top provided with a conical portion which has a wide upper end and a reduced lower end.

Preferably, the connector body is radially provided with a through hole that is perpendicular to the ground, and a hook has a first end provided with a shank extending downward and passing through the through hole, and a second end provided with a positioning portion extending downward.

Preferably, the connector body is radially provided with a through hole that is perpendicular to the ground, and an insertion pin extends through the through hole.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a connector body in accordance with the present invention.

FIG. 2 is a perspective view of a connector structure in accordance with the first preferred embodiment of the present invention.

FIG. 3 is an exploded perspective view of a connector body in accordance with the first preferred embodiment of the present invention.

FIG. 4 is a partial exploded perspective view of the connector structure, and an enlarged view of the connector body in accordance with the first preferred embodiment of the present invention.

FIG. 5 is a partial top cross-sectional view of the connector structure in accordance with the first preferred embodiment of the present invention.

FIG. 6 is a side cross-sectional view, and a partial enlarged view of the connector structure in accordance with the first preferred embodiment of the present invention.

FIG. 7 is a partial cross-sectional view of a connector structure in accordance with the second preferred embodiment of the present invention.

FIG. 8 is a perspective view of a connector structure in accordance with the third preferred embodiment of the present invention.

FIG. 9 is a partial exploded perspective view of the connector structure in accordance with the third preferred embodiment of the present invention.

FIG. 10 is a side cross-sectional view, and a partial enlarged view of the connector structure in accordance with the third preferred embodiment of the present invention.

FIG. 11 is a perspective view of a connector structure in accordance with the fourth preferred embodiment of the present invention.

FIG. 12 is a perspective view of a connector body in accordance with the fourth preferred embodiment of the present invention.

FIG. 13 is a partial exploded perspective view of the connector structure, and an enlarged view of the connector body in accordance with the fourth preferred embodiment of the present invention.

FIG. 14 is a partial top cross-sectional view of the connector structure in accordance with the fourth preferred embodiment of the present invention.

FIG. 15 is a side cross-sectional view, and a partial enlarged view of the connector structure in accordance with the fourth preferred embodiment of the present invention.

### DETAILED DESCRIPTION OF THE INVENTION

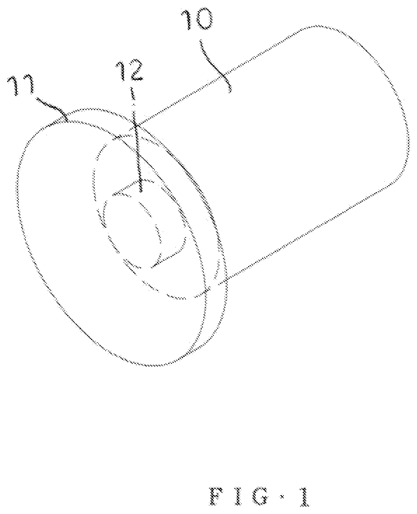

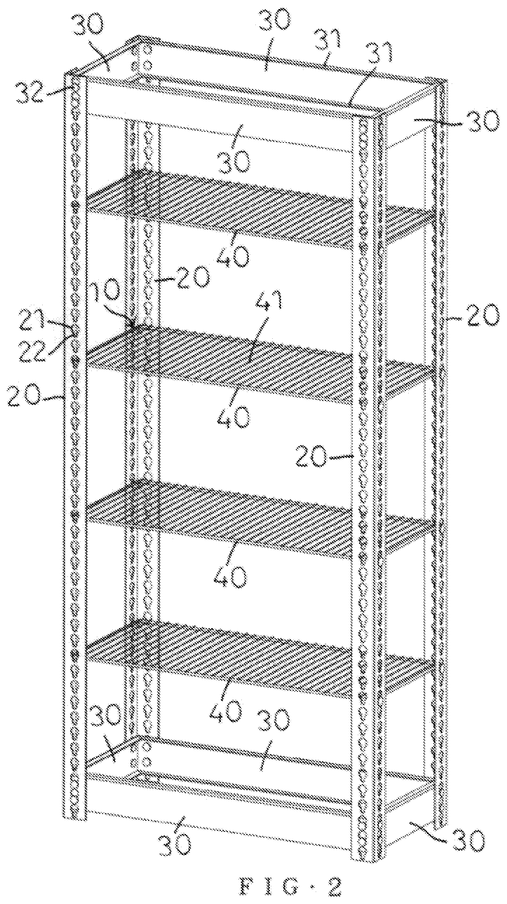

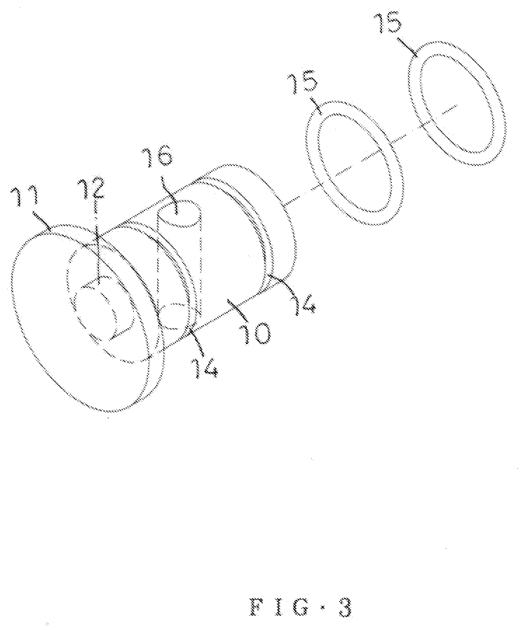

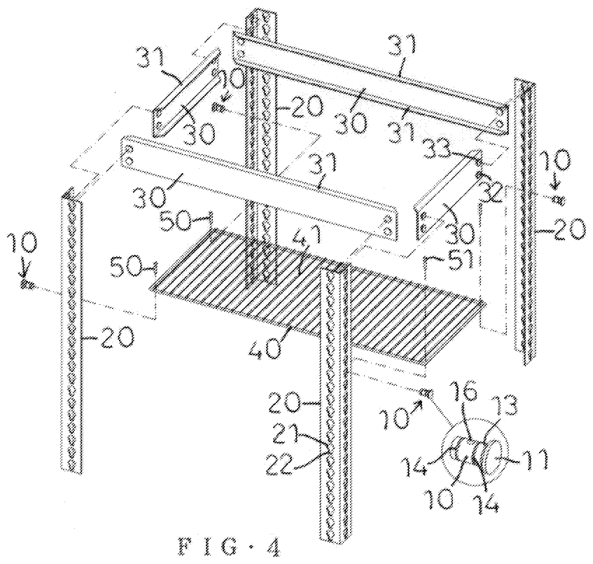

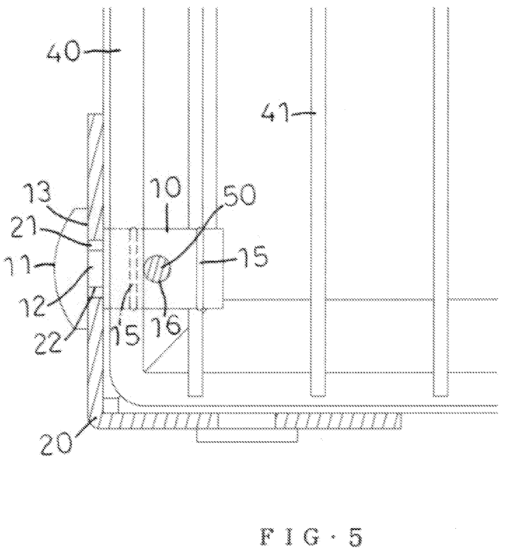

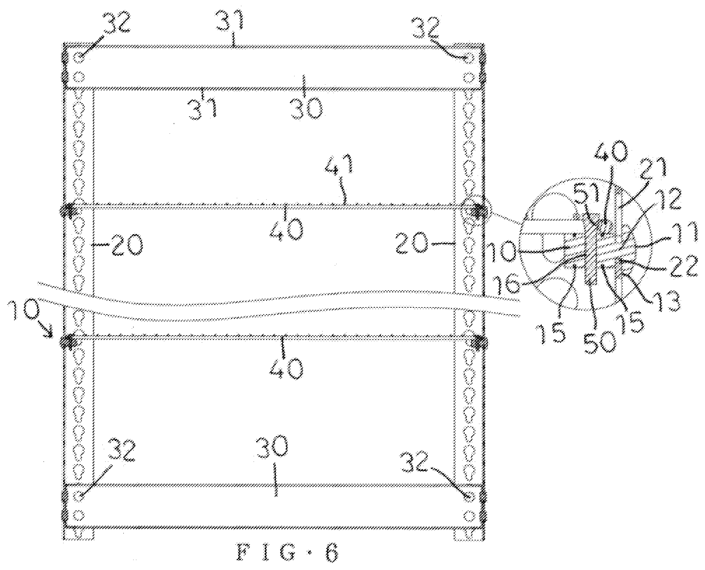

Referring to the drawings and initially to FIGS. 1-6, a connector structure in accordance with the preferred embodiment of the present invention comprises a connector body 10. The connector body 10 has a substantially cylindrical shape and has an end provided with an enlarged stop portion 11. The enlarged stop portion 11 is provided with a connecting section 12. Preferably, the enlarged stop portion 11 has a circular shape, a hexagonal shape, a tetragonal shape or rectangular shape. The connecting section 12 is located between the enlarged stop portion 11 and the connector body 10 and has a diameter smaller than that of the connector body 10. The connecting section 12 is provided with a recess (or an insertion slot) 13 which is formed integrally between the enlarged stop portion 11 and the connector body 10. The connector body 10 has a periphery provided with two annular grooves 14, and two O-rings 15 are mounted in the two annular grooves 14 to increase friction between the connector body 10 and an object, and to enhance a positioning effect. The connector body 10 is radially provided with a through hole 16, and a pin (fixing pin or securing pin or retaining pin) 50 extends through the through hole 16. The through hole 16 of the connector body 10 is located between the two annular grooves 14 and is perpendicular to the ground.

A combination shelf in accordance with the preferred embodiment of the present invention comprises a plurality of connector bodies 10, a plurality of (preferably four) upright steel angles 20, a plurality of transverse connecting plates 30, a plurality of separation (or dividing or spacing) nets 40, and a plurality of pins 50.

Each of the steel angles 20 has a thickness equal to the width of the recess 13 of each of the connector bodies 10, and is provided with a plurality of slots. Each of the slots has a gourd shape and is provided with an entrance 21, and a locking hole 22 located under and connected to the entrance 21. The entrance 21 has an inner diameter equal to an outer diameter of each of the connector bodies 10. The locking hole 22 has an inner diameter smaller than that of the entrance 21 and equal to an outer diameter of the connecting section 12 of each of the connector bodies 10. After each of the connector bodies 10 is inserted into the entrance 21 of each of the steel angles 20, the connecting section 12 of each of the connector bodies 10 is moved downward and inserted into the locking hole 22 of each of the steel angles 20, and the recess 13 of each of the connector bodies 10 is locked onto the inner wall and the outer wall of each of the steel angles 20, such that each of the connector bodies 10 is secured to each of the steel angles 20.

The transverse connecting plates 30 are located at upper and lower positions of the steel angles 20. Each of the transverse connecting plates 30 is provided with two wings 31, and a plurality of rivets protruding outward therefrom. Each of the rivets is provided with a hanging (or hooked) portion 32, and a hanging (or hooked or retaining) opening 33. The hanging portion 32 has an outer diameter equal to the inner diameter of the entrance 21. The hanging opening 33 has a width equal to the thickness of each of the steel angles 20. After the hanging portion 32 of each of the rivets is inserted into the entrance 21 of each of the steel angles 20, the hanging portion 32 of each of the rivets is moved downward and inserted into the locking hole 22 of each of the steel angles 20, and the hanging opening 33 of each of the rivets is locked onto the inner wall and the outer wall of each of the steel angles 20, such that each of the transverse connecting plates 30 is secured to each of the steel angles 20.

Each of the separation nets 40 is preferably a grid board and has a surface provided with a plurality of spacing bars 41 for placing articles. Each of the separation nets 40 is located between the steel angles 20 and has four corners placed on and supported by the connector bodies 10 which are secured on the steel angles 20 respectively. At this time, the two O-rings 15 increase the friction and the positioning effect between each of the connector bodies 10 and each of the separation nets 40.

Each of the pins 50 is inserted through the through hole 16 of each of the connector bodies 10 and has a top provided with a conical (or tapered) portion 51 which has a wide upper end and a reduced lower end, to form a closely fit between the conical portion 51 of each of the pins 50 and the through hole 16 of each of the connector bodies 10. Thus, the pins 50 are located at the four corners of each of the separation nets 40 to enhance the strength of the separation nets 40, thereby preventing the central position of the separation nets 40 from falling down due to insufficient support.

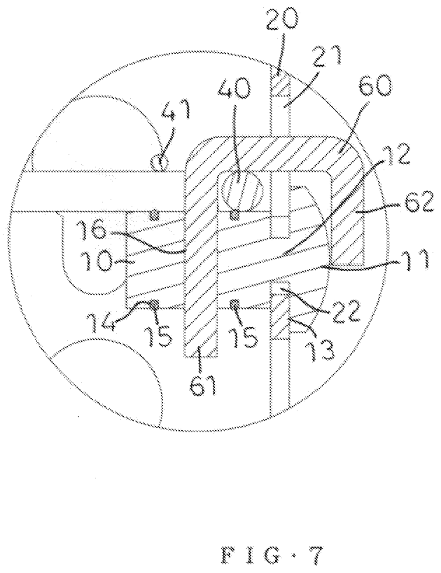

Referring to FIG. 7 with reference to FIGS. 1-6, the combination shelf further comprises a plurality of hooks (fixing hooks or securing hooks or retaining hooks) 60 to replace the pins 50. Each of the hooks 60 has a substantially 7-shaped profile and has a first end provided with a shank 61 extending downward and passing through the through hole 16 of each of the connector bodies 10, and a second end provided with a positioning portion 62 extending downward. The shank 61 has a length greater than that of the positioning portion 62. Thus, the separation nets 40 are secured to the connector bodies 10 and the steel angles 20 by the hooks 60. In addition, the hooks 60 are located at the four corners of each of the separation nets 40 to enhance the strength of the separation nets 40, thereby preventing the central position of the separation nets 40 from falling down due to insufficient support.

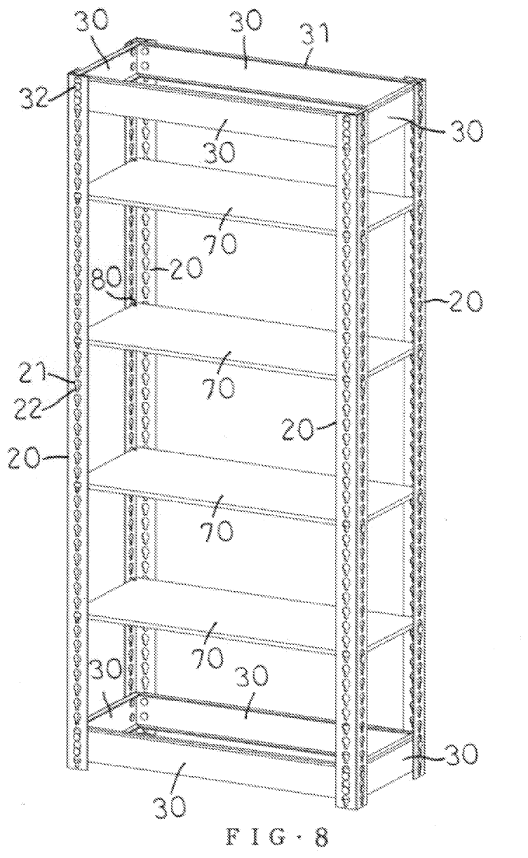

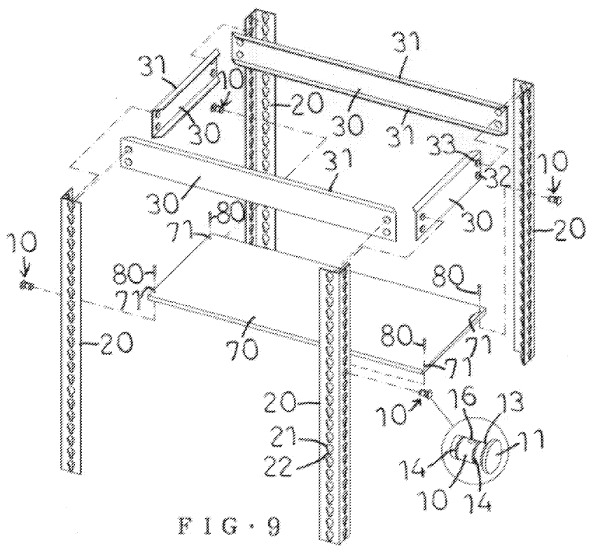

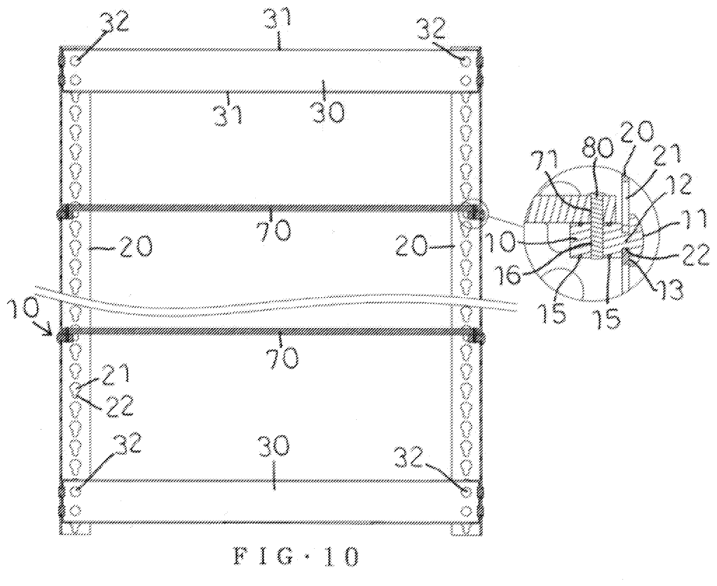

Referring to FIGS. 8-10, the combination shelf further comprises a plurality of separation boards 70 to replace the separation nets 40, and a plurality of insertion pins 80 to replace the pins 50. Each of the separation boards 70 is made of wood or metal and is provided with a plurality of apertures 71. Each of the separation boards 70 is located between the steel angles 20 and has four corners placed on and supported by the connector bodies 10 which are secured on the steel angles 20 respectively. At this time, the two O-rings 15 increase the friction and the positioning effect between each of the connector bodies 10 and each of the separation boards 70. Each of the insertion pins 80 is inserted through each of the apertures 71 of each of the separation boards 70 and through the through hole 16 of each of the connector bodies 10, such that the separation boards 70 and the connector bodies 10 are combined together by the insertion pins 80.

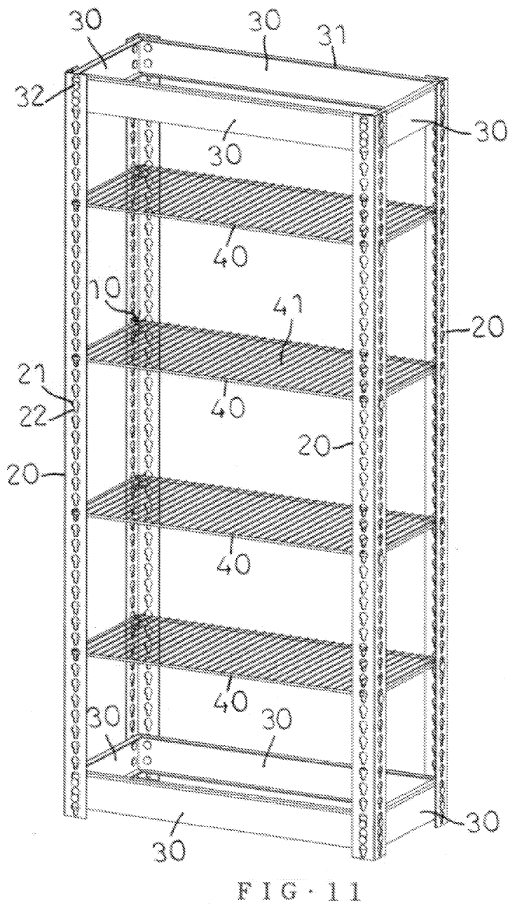

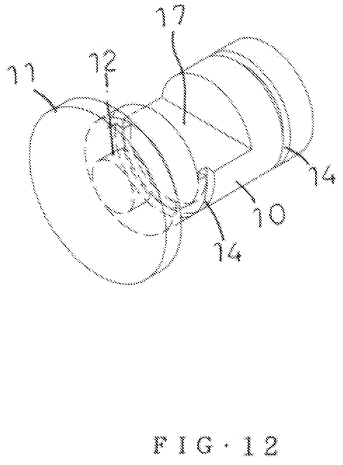

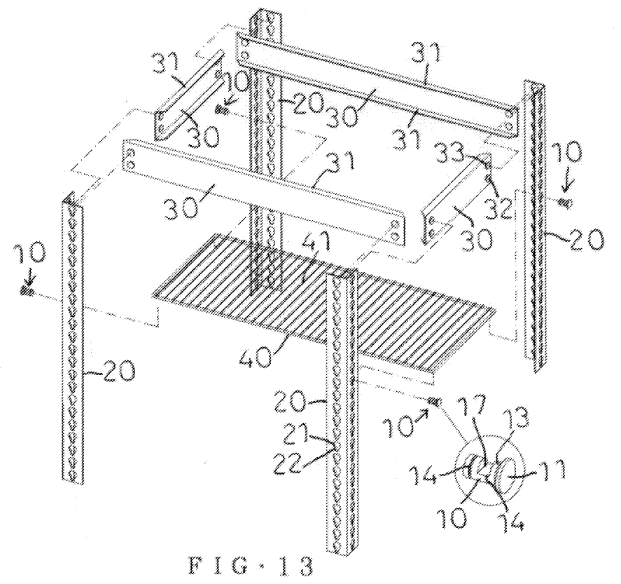

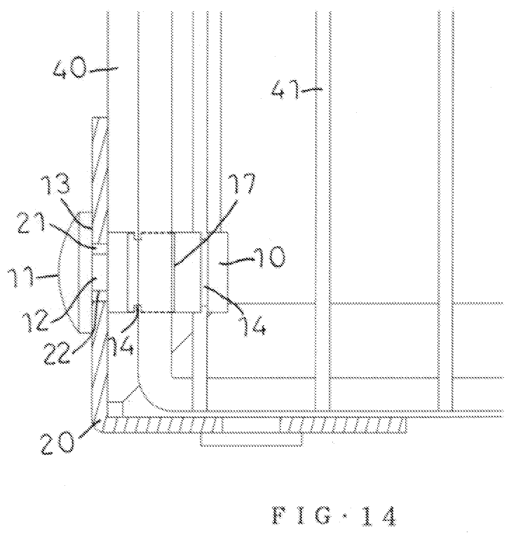

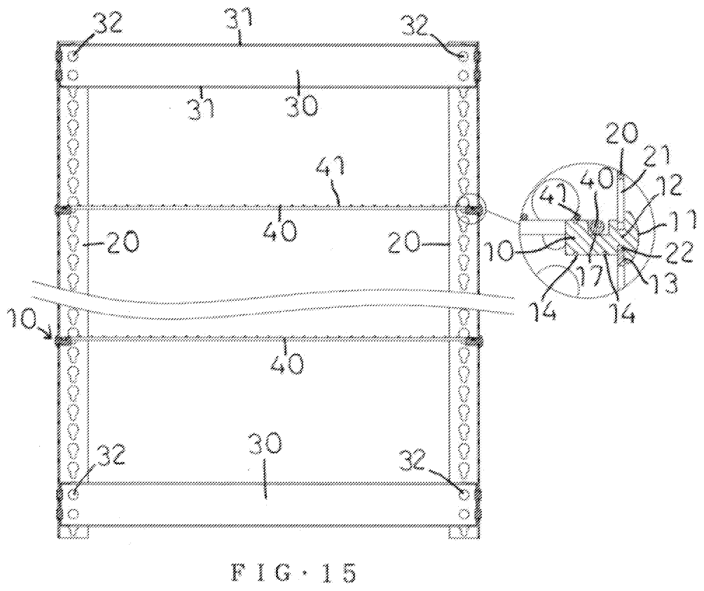

Referring to FIGS. 11-15, the connector body 10 is radially provided with a mounting recess 17 which is located between the two annular grooves 14. Thus, each of the four corners of each of the separation nets 40 is mounted in the mounting recess 17 of each of the connector bodies 10,

Accordingly, each of the connector bodies 10 is initially inserted into the entrance 21 of each of the steel angles 20, the connecting section 12 of each of the connector bodies 10 is then moved downward and inserted into the locking hole 22 of each of the steel angles 20, and the recess 13 of each of the connector bodies 10 is then locked onto the inner wall and the outer wall of each of the steel angles 20, such that each of the connector bodies 10 is secured to each of the steel angles 20 easily and quickly, thereby saving the cost, and thereby saving the time, and the energy of assembly. In addition, the connector bodies 10 and the steel angles 20 are combined solidly and stably. Further, the separation nets 40 or the separation boards 70 are directly placed on the connector bodies 10, such that the combination shelf has the maximum storage space. Further, the separation nets 40 or the separation boards 70 are arranged between the transverse connecting plates 30 to largely decrease the number of the transverse connecting plates 30, thereby enhancing the aesthetic quality of the combination shelf.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A connector structure comprising:
a connector body;
wherein:
the connector body has an end provided with an enlarged stop portion;
the enlarged stop portion is provided with a connecting section;
the connecting section has a diameter smaller than that of the connector body; and
the connecting section is provided with a recess which is formed integrally between the enlarged stop portion and the connector body.

2. The connector structure of claim 1, wherein the connector body has a substantially cylindrical shape.

3. The connector structure of claim 1, wherein the enlarged stop portion has a circular shape, a hexagonal shape, a tetragonal shape or rectangular shape.

4. The connector structure of claim 1, wherein the connector body has a periphery provided with two annular grooves, and two O-rings are mounted in the two annular grooves.

5. The connector structure of claim 1, wherein the connector body is radially provided with a mounting recess.

6. The connector structure of claim 1, wherein:
the connector body is radially provided with a through hole that is perpendicular to the ground;
a pin extends through the through hole; and
the pin has a top provided with a conical portion which has a wide upper end and a reduced lower end.

7. The connector structure of claim 1, wherein:
the connector body is radially provided with a through hole that is perpendicular to the ground; and
a hook has a first end provided with a shank extending downward and passing through the through hole, and a second end provided with a positioning portion extending downward.

8. The connector structure of claim 1, wherein the connector body is radially provided with a through hole that is perpendicular to the ground, and an insertion pin extends through the through hole.
